(19) United States
(12) Patent Application Publication
(10) Pub. No.: US 2009/0308224 A1
(43) Pub. Date: Dec. 17, 2009

(54) Percussion Instrument and Method of Use

(76) Inventor: Matthew Ledgar, Bonville (AU)

Correspondence Address: PATWRITE LLC, 408 W. MAIN ST., MARSHALLTOWN, IA, 50158-5759, US

(21) Appl. No.: 12/490,119

(22) Filed: Jun. 23, 2009

Related U.S. Application Data
(63) Continuation-in-part of application No. 10/556,264, filed on Nov. 14, 2005, now Pat. No. 7,572,965.

(30) Foreign Application Priority Data
May 5, 2004 (AU) PCT/AU2004/000616

(51) Int. Cl. G10D 13/02

(52) U.S. Cl. 84/402

(57) ABSTRACT

A percussion instrument has at least one transformable jingle set mounted therein. Each jingle set has a horizontal supporting member that moveably holds jingles within the transformable jingle set along a central axis. At least one fixing member is mounted at substantially a right angle to the horizontal supporting member to hold the horizontal supporting member in place. Both the horizontal supporting member and the at least one fixing member fit within a notch in an instrument frame. The fixing member and horizontal support member may be removed and a different jingle configuration is selected and reinserted thereby changing the musical timber therein.

### CROSS REFERENCE TO RELATED APPLICATIONS

This application is a Continuation-In-Part of now allowed U.S. patent application Ser. No. 10/556,264 which is the U.S. national stage entry from International Patent Application Ser. No. PCT/AU2004/000616, filed May 5, 2004, the complete disclosures of each of which are hereby incorporated by reference.

### BACKGROUND OF THE INVENTION

Musicians utilize percussion instruments to establish beat. In many styles of music musicians use a number of types of percussion instruments to establish complex structures to the beat. In order to employ a number of types of percussion instruments it is generally necessary to utilize a number of musicians or arrange the music in a manner in which the operation of multiple percussion instruments are staggered. A limited number of percussion instruments allow more than one type sound to be produced. These types of percussion instruments require the use of complex actions to generate multiple types of percussive sounds. Either the musician must use an additional hand or must interrupt the playing of the first instrument in order to produce a second percussive sound.

The use of a number of musicians to play percussion instruments is generally impractical. Bands of musicians that perform are limited in size for economic and logistic factors. In order for a band of musicians to be economically viable, it is necessary for their numbers to be limited. Further, the coordination of a large number of musicians is logistically complex and, from a musical timing point of view, difficult to control. Accordingly, it is desirable to maximize the usage of the musicians by enabling the musicians to produce a greater number of sounds.

There have previously been produced a variety of compound instruments that are able to produce a plurality of sounds types. For example, musicians often utilize a guitar not only as a stringed instrument but also as a percussion instrument by striking of the hollow body of the guitar. This use of a guitar takes advantage of the hollow body of the guitar rather than its conventional use. In a drum kit a multiplicity of percussion instruments are provided.

There may be a variety of different drum types as well as cymbals that maybe struck by the drummer. While the drummer may play one or more drums, in order to play the cymbals the drummer either has to strike the cymbals with a drumstick in the inactive hand or interrupt playing the drums.

Musicians utilize tambourines to establish beat. In many styles of music musicians use a number of tambourines to compliment the style and sound that is deemed by the musician to be best for the music at hand. Tambourines usually have a sound that is not changeable due to the fact that it is not possible to remove the jingles. In order to change tambourine sounds a musician would pick up a different tambourine that produces a lighter or darker sound than the one played previously.

There is a need for a musical transformable percussive instrument that allows for easy change of the sounds without changing instruments.

### SUMMARY OF THE INVENTION

A percussion instrument has at least one transformable jingle set mounted therein. Each jingle set has a horizontal supporting member that moveably holds jingles within the transformable jingle set along a central axis. At least one fixing member is mounted at substantially a right angle to the horizontal supporting member to hold the horizontal supporting member in place. Both the horizontal supporting member and the at least one fixing member fit within a notch in an instrument frame. The fixing member and horizontal support member may be removed and a different jingle configuration is selected and reinserted thereby changing the musical timber therein.

The present invention is for a compound percussion instrument that enables a musician to operate simultaneously two percussive instruments without having to utilize an additional hand. According to the present invention there is provided a compound percussion instrument comprising a first percussive instrument and a second percussive instrument wherein the first percussive instrument is operable by a player using at least one hand and wherein the second percussive instrument is simultaneously operable by a player using said at least one hand wherein said second percussive instrument comprises a hammer, at least one anvil and an actuator wherein the actuator is disposed on the first percussive instrument and operates the hammer and causes the hammer to strike the anvil.

The first percussive instrument has a handle and the actuator is disposed on the handle of the first percussive instrument.

In one embodiment, the percussion may include a plurality of hammers actuated by the actuator.

The compound percussion instrument of the present invention advantageously may be played such that both the first and second percussive instruments may be played independently or in concert whereby notes may be played on the first and second percussive instruments simultaneously. The compound percussion instrument allows a musician to add an additional instrument to a musical composition without having to introduce additional musicians, and to augment an instrument with a readily operable secondary instrument so as to create a new sound or sounds.

The first percussive instrument may be any desired percussive instrument. For example, the first percussive instrument may be a tambourine, shaker, rattle, bells or the like.

In an embodiment of the present invention the first percussive instrument is a tambourine. The tambourine includes a frame on which a plurality of jingles, metal disks or bells are mounted. Typically a tambourine will have two rows of jingles disposed around the rim. The tambourine of the first embodiment of the present invention includes three rows of jingles disposed around the rim. Tambourines typically include a portion of the rim that is free of jingles that provides a handle for the musician. The handle may be shaped to conform to the hand of the musician. Tambourines are typically operated by a rhythmical shaking action of the wrist. The rhythmical shaking action of the wrist is a continuous action that maybe interrupted by striking the tambourine against the musician's body. This type of action generally precludes the musician operating a second instrument with the same hand simultaneously.

Other percussive instruments may be used as the first percussive instrument. It will be apparent to those skilled in the art that percussive instruments that are operable with a single hand may advantageously incorporate a second percussive instrument of the type described herein. Such percussive instruments are generally operated by the musicians simultaneously with other instruments, such as keyboards or a microphone.

The second percussive instrument comprises a hammer, at least one anvil and an actuator wherein the actuator operates the hammer and causes the hammer to strike the anvil. The hammer maybe formed in any convenient configuration. The hammer is mounted to strike the anvil. The hammer may be pivotally mounted on the compound percussion instrument such that the hammer may pivot to strike the anvil. In another configuration, the hammer may be slidably mounted on the compound percussion instrument or in another manner that permits the hammer to strike the anvil.

In one embodiment, the hammer may be biased to a primed condition. The hammer may be biased using a spring, of the coiled or leaf type, or using an over center pivotal mount. The hammer be biased to a primed condition with an over center pivotal mount having opposed anvils on either side of the pivot point. The hammer is biased using a coil springs such that in a primed condition of the hammer rests against one of the anvils.

In another embodiment, the compound percussion instrument includes a single anvil and the hammer is biased to a primed position in which a striking surface of the hammer is spaced from the anvil.

In one form of the invention the hammer maybe chosen to provide the desired acoustic response. In this embodiment, the hammer may be in the form of a temple block. A temple block is a hollow member having at least one opening. Sound produced by striking the temple block against the anvil resonates within the temple block and is emitted therefrom.

In another embodiment, the at least one anvil may be chosen to provide the desired acoustic response. Either the at least one anvil or the hammer, or both, may provide the desired acoustic response. Generally it is preferred that either the at least one anvil or the hammer provide the desired acoustic response. For example, where the hammer is chosen to provide the desired acoustic response the at least one anvil may be a rigid member that has little or no acoustic response. Alternatively, where the hammer is a relatively rigid member having little or no acoustic response the at least one anvil is adapted to provide the desired acoustic response.

In a one configuration the hammer is in the form of a temple block that strikes opposed anvils on either side of a pivotal mount. The opposed anvils may be in the form of projections extending from the frame of the compound percussion instrument. The hammer is actuated by an actuator that causes the hammer to strike the anvil. The actuator is associated with the handle of the compound percussion instrument such that the musician may operate the actuator while holding the compound percussion instrument in a manner suited for the playing of the first percussive instrument. The actuator may be directly connected to the hammer and form an extension therefrom. The actuator is indirectly connected to the hammer via a linkage. The linkage may be a chain, a cord, a bar or a member. The actuator is in the form of a trigger.

In another embodiment, the temple block is a slit drum having a tear dropped shape cross section. The slit will run from an aperture in each end wall of the slit drum along the midline of the slit drum. The temple block or slit drum may be fixedly mounted at its sharp end to the frame of the instrument or it may be hingedly mounted at its sharp end to the frame of the instrument.

Other features and advantages of the instant invention will become apparent from the following description of the invention which refers to the accompanying drawings.

According to an embodiment of the present invention there is provided a tambourine comprising jingles that maybe slidably mounted in double or triple sets of jingles in one two or three sections upon a supporting member that lies centrally located over rectangular or square space in the frame of the tambourine, the supporting member is slightly longer than the space provided and lies in two notches placed centrally and opposite each other in the top side of the tambourine frame at each end of the space and is held in place by a fixing member or members that lie perpendicularly over the supporting member and locate into notches opposite each other on the underside of the tambourine frame.

### BRIEF DESCRIPTION OF THE DRAWINGS

FIG. 1 shows a perspective view of a compound percussion instrument according to one embodiment of the present invention.

FIG. 2 shows a perspective view of a compound percussion instrument according to a second embodiment of the present invention.

FIG. 3 shows a front view of part of a tambourine in accordance with a further embodiment of the present invention.

FIG. 4 shows a rear view of FIG. 3.

FIG. 5 is a schematic diagram showing the actuating mechanism for operating the hammer of the tambourine shown in FIGS. 3 and 4.

FIG. 6 is a side view of the front side of a transformable jingle set mounted with a tambourine frame according to an embodiment of the present invention.

FIG. 7 is a side view of the back side of the transformable jingle set shown in FIG. 6.

FIG. 8 is a side view of the front side of a transformable jingle set mounted with a tambourine frame after transforming by selecting a different jingle configuration.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

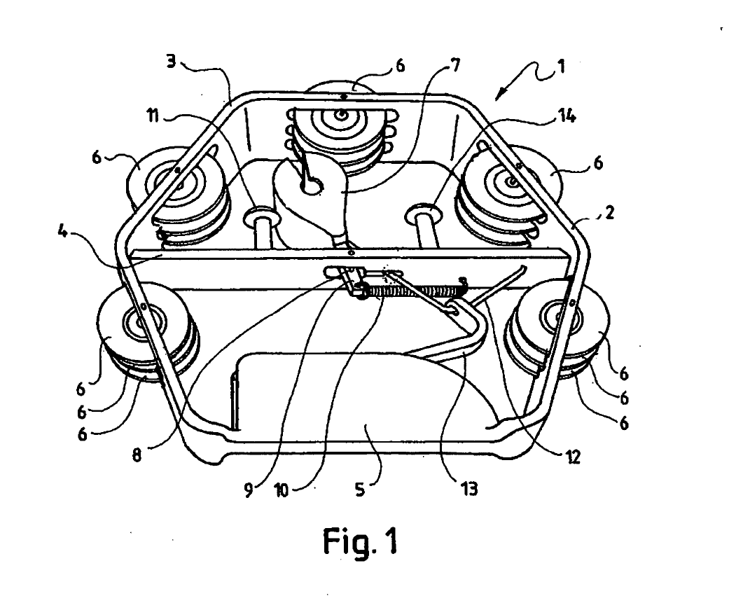

A tambourine 1 is shown in FIG. 1. The tambourine 1 is formed from a frame 2. The frame 2 includes a rim 3 and a brace 4. A handle 5 is mounted on the rim 3.

The rim 3 supports a plurality of jingles 6 mounted in the three rows 25 and was placed around the rim 3. A musician is able to play the tambourine 1 by holding the handle 5 and shaking the tambourine 1 causing the jingles 6 to jangle. The brace 4 extends diametrically within the rim 3. A hammer, in the form of a temple block 7, is mounted on the brace 4. A pivotal mount 8 extends through the brace 4 and an extension 9 of the temple block 7 is attached to a compression spring 10. The compression spring 10 is fixed to the brace 4. The compression spring 10 holds the temple block 7 against the first anvil 11. A cord 12 is attached to the temple block 7 above the pivotal mount 8. The cord 12 is also attached to the brace 4. A trigger 13 is pivotally connected to the handle 5 and the cord passes through the remote end of the trigger 13. The musician may call the trigger 13 to rotate the temple block 7 such that it strikes the second anvil 14. By releasing the trigger 13 the compression spring 10 returns of the temple block 7 such that it strikes of the first anvil 11.

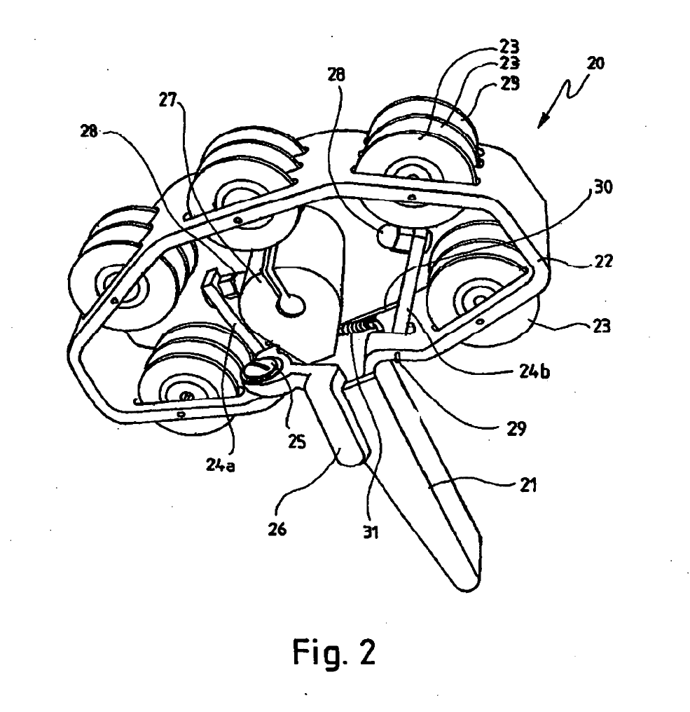

FIG. 2 shows a tambourine 20 having a frame 22 mounted on a handle 21. The frame 22 has five sets of jingles 23 disposed around the frame 22. The jingles are mounted to jangle by the musician shaking the frame. An anvil, in the form of a temple block 27, is fixedly mounted to the frame 22 above the handle 21. A pair of opposed hammers 28 are mounted on 10 respective arms 24. The respective arms 24 are interconnected by a cord 30. The respective arms 24 are biased with a spring 31. A lever 26 is pivotally mounted on the frame 22 by a pivot mount 25 in the form of a bolt. The trigger 26 is connected to the arm 24a such that on depression of the trigger 26 arm 24a pivots away from the temple block 27 and arm 24b moves towards the temple block 27 and causes the hammer 28 mounted on arm 24b to strike the temple block.

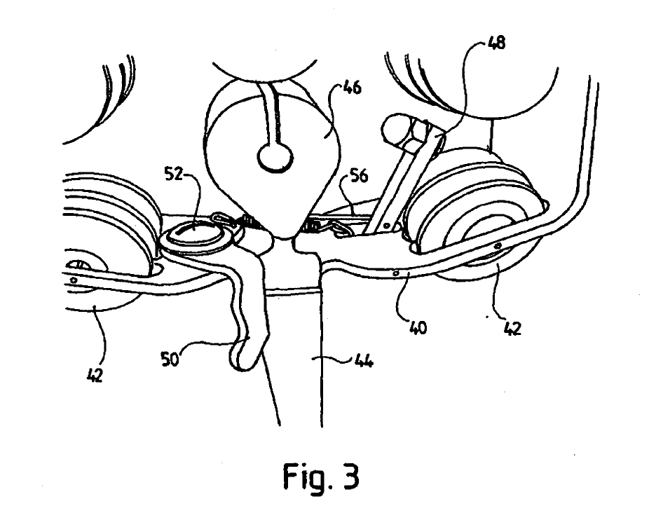

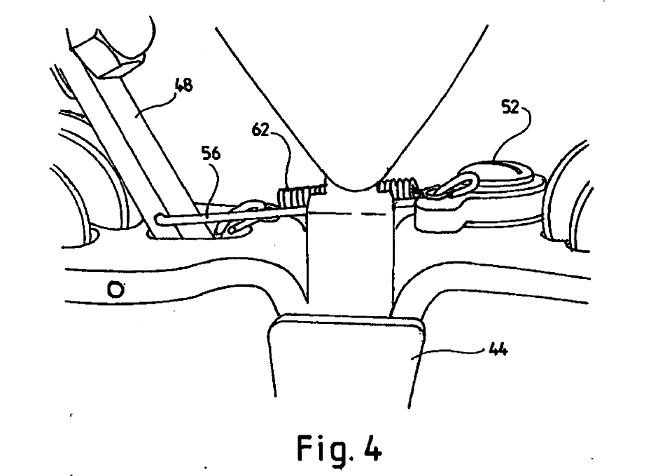

The tambourine shown in FIGS. 3 to 5 comprises a rim 40 having a plurality of jingles 42 mounted thereto. A handle 44 depends from the rim 40 and allows a musician to hold the tambourine for use.

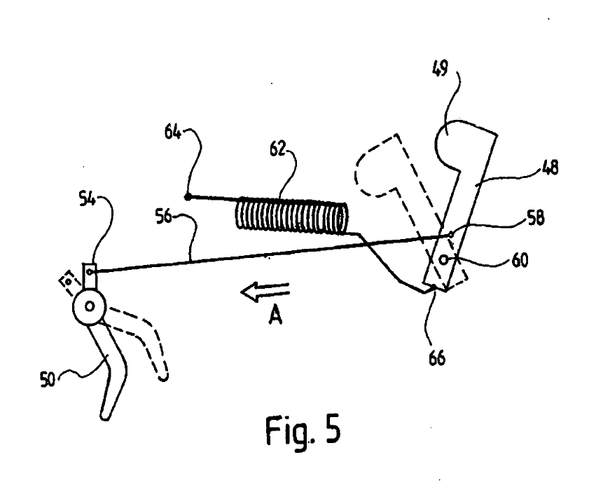

The tambourine further includes an anvil in the form of a temple block 46 fixedly mounted to the rim 40. A hammer 48 is arranged to strike the temple block 46. In order to actuate the hammer 48, a trigger 50 is pivotally mounted at pivot mount 52 on the rim 40. Trigger 50 has a radially extending arm 54 extending outwardly therefrom. Solid linkage 56 interconnects the arm 54 of the trigger 50 to hammer 48. As schematically shown in FIG. 5, the solid linkage 56 is pivotally 25 connected at point 58 to trigger 50. Point 58 is located above pivot point 60 at which the hammer is pivotally mounted to the rim 40 of the tambourine.

A tension spring 62 is mounted at one end 64 to the rim 40. The other end of the tension spring 62 is mounted at point 66 to the lower end of hammer 48. As can be best seen in FIG. 5, point 66 is located below pivot point 60 at which the hammer 48 is mounted to the rim 40. As a result, the tension spring 62 biases the hammer 48 in a primed position in which the striker 49 of the hammer 48 is positioned away from the temple block 46. This position is shown in solid outline in FIG. 5.

In use, the musician can actuate the hammer by pressing the trigger 50 to cause it to rotate about pivot mount 52 and adopt the position shown in broken outline in FIG. 5. This causes solid linkage 56 to move in the direction of arrow A which causes the hammer 48 to pivot about point 60 and move to apposition shown in broken outline in FIG. 5. In this position, the hammer 48 strikes the temple block 46. Spring 62 is stretched such that when the musician releases the trigger 48 the spring 62 moves the hammer 48 back to the primed position shown in solid outline in FIG. 5. This also resets the trigger 50 to the position shown in solid outline in FIG. 5.

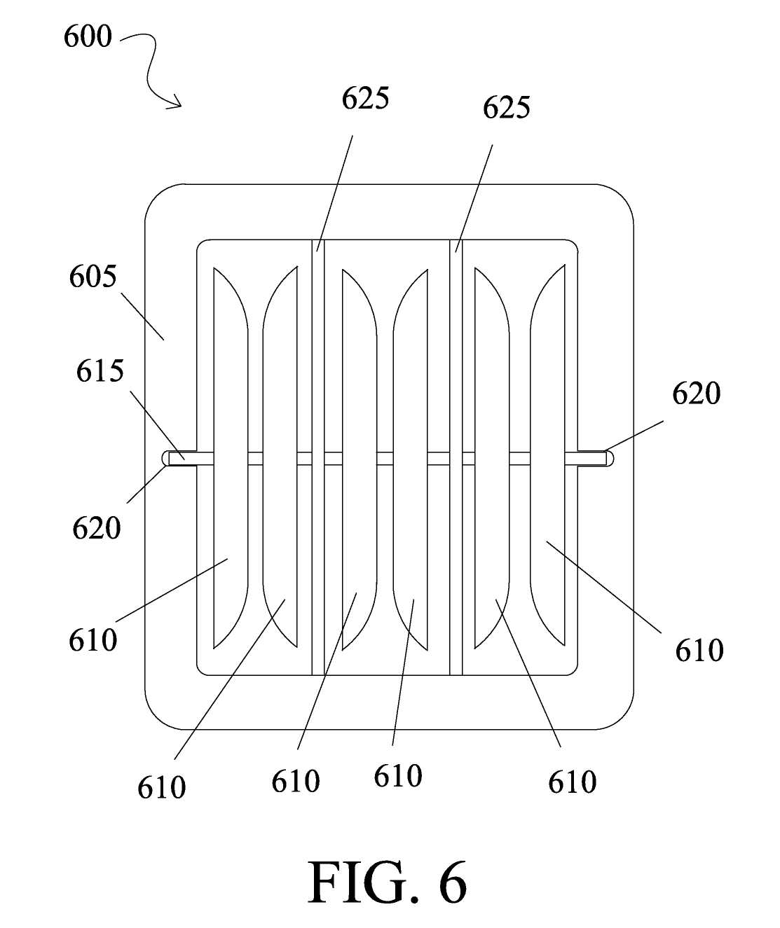

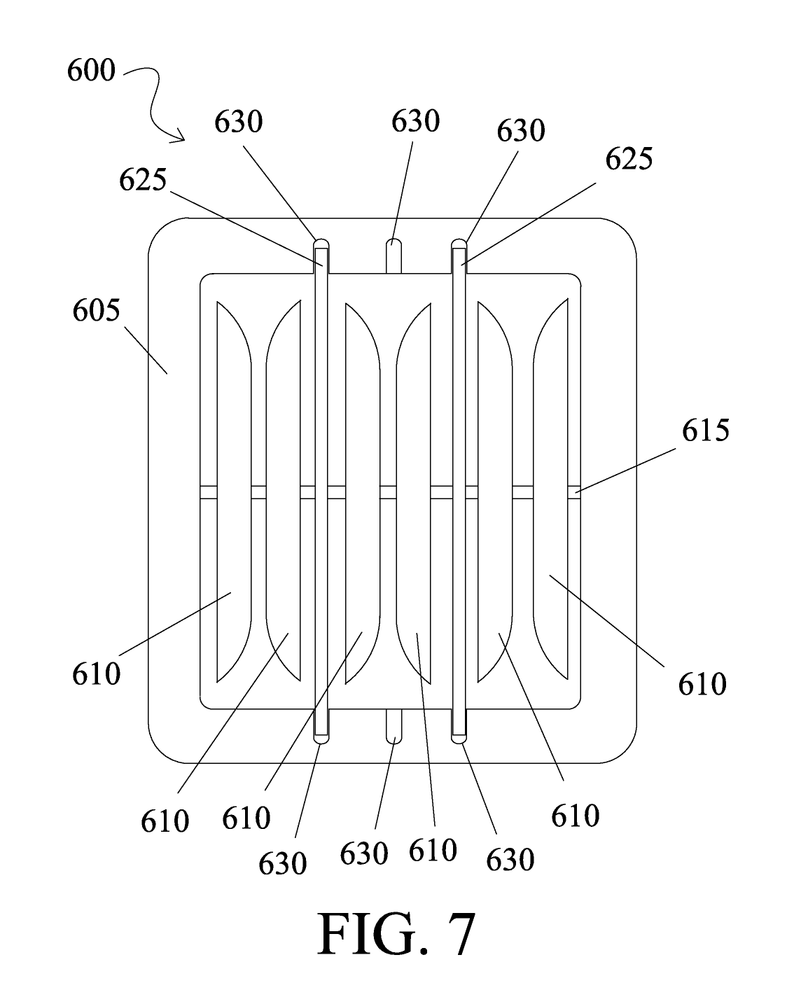

Referring to FIGS. 6 and 7 a transformable jingle set 600 is shown mounted within a tambourine frame 605. A plurality of jingles 610 are moveably supported by a support member 615 which removably fits within a supporting member notch 620 that is formed within frame 605. Horizontal support member 615 is held in place using at least one fixing member 625. In the embodiment shown, two fixing members 625 are shown holding support member 615 in place. Fixing members 625 are held in place by fitting within fixing member notches 630 that are located on the opposite side of frame 605. In this way, tension is created by a weaving action by having the notches 615 and 630 on opposite sides of frame 605 respectively.

Alternatively, supporting member 625 may be held in place using friction or a securing means such as spring loaded detent, cover plate or other suitable means as long as support member 615 is securely held in place during use but is removable to change the configuration as described below.

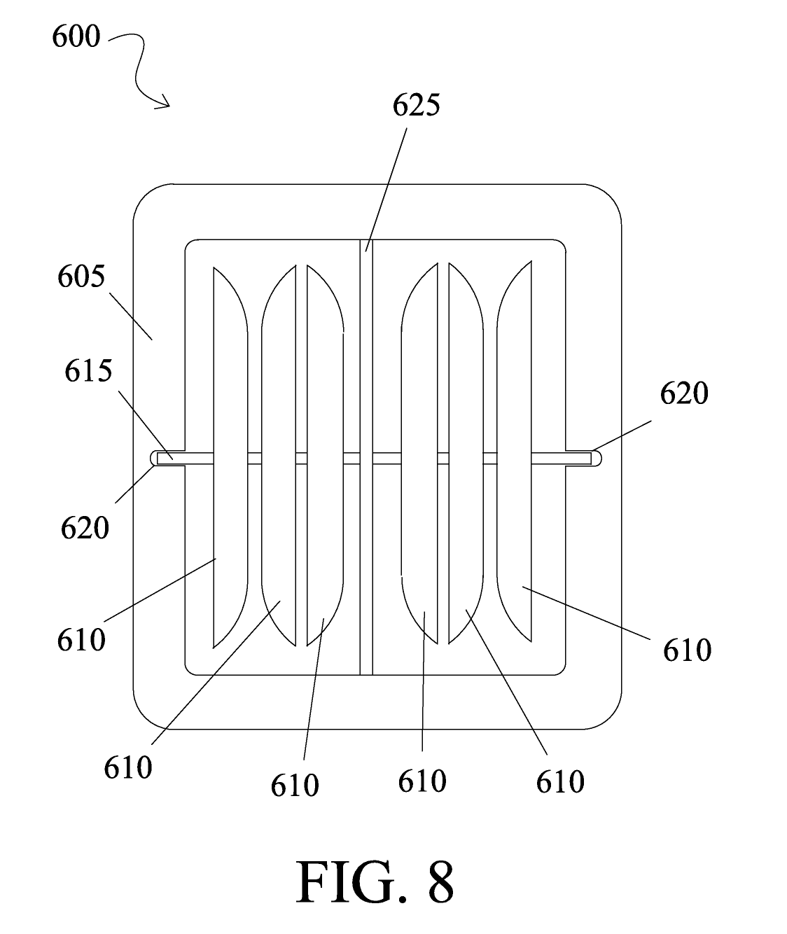

Now referring to FIG. 8, an alternative configuration has been selected by adding jingles 610 in a different configuration, thus transforming the musical qualities of the jingle set 600. Of course other configurations are possible and it would be tedious to try to represent all the different configurations possible. The two representations shown are meant to representative of configurable transformations and not meant to be exhaustive.

Although the instant invention has been described in relation to particular embodiments thereof, many other variations and modifications and other uses will become apparent to those skilled in the art.

What is claimed is:

1. A transformable jingle set mounted within a tambourine frame comprising:
a plurality of jingles;
said plurality of jingles each moveably mounted on a support member wherein said plurality of jingles may be selected to match a desired musical quality;
said support member removably mounted within said tambourine frame; and
at least one fixing member removably mounted within said tambourine frame at substantially right angle to said support member.

2. The transformable jingle set mounted within a tambourine frame according to claim 1 further comprising a support member notch disposed within said frame at each end of said support member wherein said support member removably fits therein.

3. The transformable jingle set mounted within a tambourine frame according to claim 2 further comprising at least one fixing member notch disposed on an opposite side and within said frame at each end of said at least one fixing member wherein said plurality of fixing member removably fits therein.

4. A method of transforming a percussion instrument from a given musical quality to a new musical quality comprising the steps of:
selecting a tambourine having at least one transformable jingle set disposed therein;
removing a fixing member from said transformable jingle set;
removing a support member having a first configuration of jingles moveably supported therein;
selecting a new configuration of jingles;
replacing said support member having said new configuration of jingles in said frame; and
replacing said fixing member.
